(19) United States
(12) Patent Application Publication
(10) Pub. No.: US 2021/0136043 A1
(43) Pub. Date: May 6, 2021

(54) STATE REPLICATION SYSTEM, SECURITY INSPECTION SYSTEM, AND COMPUTER READABLE MEDIUM

(71) Applicant: MITSUBISHI ELECTRIC CORPORATION, Tokyo (JP)

(72) Inventors: Keisuke KITO, Tokyo (JP); Kiyoto KAWAUCHI, Tokyo (JP); Takumi YAMAMOTO, Tokyo (JP); Hiroki NISHIKAWA, Tokyo (JP)

(73) Assignee: MITSUBISHI ELECTRIC CORPORATION, Tokyo (JP)

(21) Appl. No.: 16/639,416

(22) PCT Filed: Oct. 6, 2017
(86) PCT No.: PCT/JP2017/036522

§ 371 Date: Feb. 14, 2020

(51) Int. Cl. H04L 29/06; H04L 29/08

(52) U.S. Cl. CPC H04L 63/0414; H04L 63/20; H04L 67/1031; H04L 67/2804; H04L 67/1008

(57) ABSTRACT

A state replication apparatus (200) generates communication, between a main apparatus (421) and each sub-apparatus (422, 423), to cause a state combination to transit in accordance with transition order specified in an acquisition scenario. The state replication apparatus records each of the communication generated between the main apparatus and the each sub-apparatus. The state replication apparatus acquires a snapshot combination at each of acquisition timings specified in the acquisition scenario. The state replication apparatus replicates each of the main apparatus and the each sub-apparatus in states of a replication state combination based on the acquired each snapshot combination and the recorded each communication.

### TECHNICAL FIELD

The present invention relates to a technique of replicating each apparatus in a desired state in order to carry out a security inspection, such as a penetration test.

### BACKGROUND ART

A great number of cyberattacks mostly use a software bug installed in a system.

At the time of shipment of products, a test to verify whether software is installed in compliance with specifications is carried out.

However, this test does not verify whether the software is securely installed from a perspective of security.

Therefore, recently, attention has been riveted to a penetration test prior to shipment. The penetration test is a test to verify whether it is possible to break into a system.

In the penetration test, various cyberattacks are attempted against the system when the system is operating. And, it is verified whether it is possible to break into the system.

The penetration test is implemented in a state in which the system operates, so-called a system testing state. Therefore, if the system consists of a plurality of computers, a plurality of computers need to be prepared.

In the penetration test, it is necessary to verify whether it is possible to break into the system in every possible state of the system.

For example, the state and behavior of a server of a system of a client-server model change depending on a state of a client. Therefore, the penetration test must be implemented by changing the state of the client.

If a virtual computer is used instead of each real-life computer included in the system, it is necessary to acquire snapshots of a plurality of virtual computers for each combination of a plurality of real-life computers.

Patent Literature 1 discloses a technique of replicating a state of a system while reducing the number of snapshots.

According to this technique, a state after a snapshot has been acquired is transmitted to a virtual computer in which the snapshot is loaded, using a communication packet that has been captured in advance.

Patent Literature 2 discloses a technique of replicating a state of a system while reducing the number of snapshots.

According to this technique, if a failure occurs, a snapshot immediately before the occurrence is loaded. And, based on a record of a communication packet before a point of time of the occurrence of the failure, a state at the point of time of the occurrence of the failure is replicated.

Patent Literature 3 discloses a technique of reducing a size of a snapshot.

According to this technique, states of a system are represented by a tree structure. And, a parent node of a node in a state that is to be replicated is chosen, and difference from a state of the parent node is used as a snapshot.

Patent Literature 4 discloses a technique of shortening duration of time before replication of a state while reducing the number of snapshots.

According to this technique, duration of time and computational complexity of state transition of a system are defined as a transition cost. And, by keeping a snapshot (a snapshot immediately after the transition) with a large transition cost, a snapshot that is replicable in a short time is deleted.

### CITATION LIST

### Patent Literature

Patent Literature 1: JP 2009-080705 A

Patent Literature 2: International Publication WO 2010/134177

Patent Literature 3: JP 2013-120440 A

Patent Literature 4: International Publication WO 2015/008377

### SUMMARY OF INVENTION

### Technical Problem

Since conventional techniques require acquisition of a snapshot even of a computer of which state does not transit, the conventional techniques have been inefficient.

An objective of the present invention is to make each apparatus be replicable in a desired state while reducing the number of snapshots.

### Solution to Problem

A state replication system of the present invention includes:

a storage unit to store an acquisition scenario in which transition order and a plurality of acquisition timings are specified, the transition order being order in accordance with which a state combination of a state of a main apparatus and a state of each of a plurality of sub-apparatuses is caused to transit, the plurality of acquisition timings being timings at which a snapshot combination of a snapshot of the main apparatus and a snapshot of the each sub-apparatus is acquired;

a communication control unit to generate communication, between the main apparatus and the each sub-apparatus, to cause the state combination to transit in accordance with the transition order specified in the acquisition scenario;

a communication record unit to record each of the communication generated between the main apparatus and the each sub-apparatus; and

a snapshot acquisition unit to acquire a snapshot combination at each of the acquisition timings specified in the acquisition scenario.

### Advantageous Effects of Invention

According to the present invention, a snapshot combination is acquired in accordance with an acquisition scenario. Therefore, by appropriately specifying a plurality of acquisition timings in the acquisition scenario, it becomes possible to acquire a snapshot of each sub-apparatus for each state of the each sub-apparatus. A snapshot of a main apparatus is also acquired at the same timing as that of the snapshot of the each sub-apparatus. Further, in order to cover a shortage of the snapshot of the main apparatus, communication generated between the main apparatus 421 and the each sub-apparatus is recorded. This enables replication of each of the main apparatus and the each sub-apparatus in states of a replication state combination while reducing the number of snapshots.

### BRIEF DESCRIPTION OF DRAWINGS

FIG. 1 is a configuration diagram of a state replication system 100 according to Embodiment 1.

FIG. 2 is a configuration diagram of a state replication apparatus 200 according to Embodiment 1.

FIG. 3 is a configuration diagram of a proxy response apparatus 300 according to Embodiment 1.

FIG. 4 is a configuration diagram of a target operation apparatus 400 according to Embodiment 1.

FIG. 5 is a flowchart of a state replication method according to Embodiment 1.

FIG. 6 is a flowchart of a snapshot acquisition process according to Embodiment 1.

FIG. 7 is a schematic diagram of the snapshot acquisition process according to Embodiment 1.

FIG. 8 is a flowchart of a state replication process according to Embodiment 1.

FIG. 9 is a flowchart of a state replication process according to Embodiment 2.

FIG. 10 is a configuration diagram of a proxy response apparatus 300 according to Embodiment 3.

FIG. 11 is a configuration diagram of a security inspection system 110 according to Embodiment 4.

FIG. 12 is a configuration diagram of a security inspection apparatus 500 according to Embodiment 4.

FIG. 13 is a flowchart of a security inspection method according to Embodiment 4.

FIG. 14 is a hardware configuration diagram of a state replication apparatus 200 according to Embodiments.

FIG. 15 is a hardware configuration diagram of a proxy response apparatus 300 according to Embodiments.

FIG. 16 is a hardware configuration diagram of a target operation apparatus 400 according to Embodiments.

FIG. 17 is a hardware configuration diagram of a security inspection apparatus 500 according to Embodiments.

### DESCRIPTION OF EMBODIMENTS

In embodiments and drawings, the same and corresponding components are denoted by the same reference signs. An explanation on a component denoted by the same reference number is omitted or simplified according to circumstances. An arrow in a drawing mainly indicates a data flow or a process flow.

### Embodiment 1

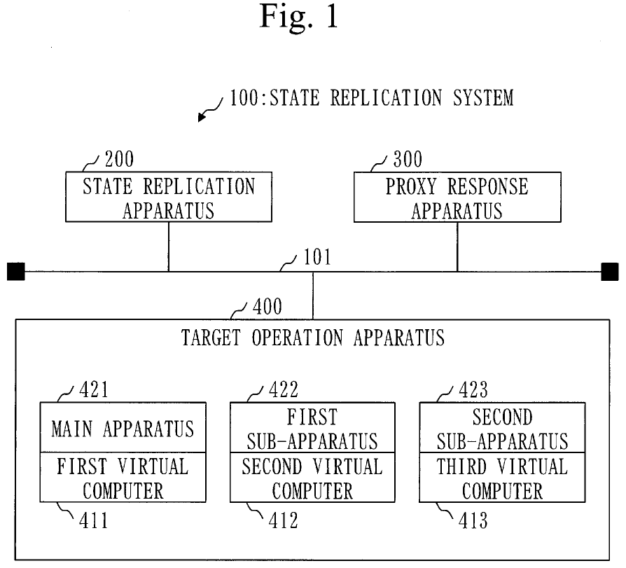

A state replication system 100 will be explained based on FIGS. 1 to 8.

*** Description of Configuration ***

Based on FIG. 1, a configuration of the state replication system 100 will be explained.

The state replication system 100 is a system to replicate, based on a snapshot and a communication record, each of a main apparatus 421, a first sub-apparatus 422, and a second sub-apparatus 423, in a desired state.

The main apparatus 421 is an apparatus that communicates with the first sub-apparatus 422 and the second sub-apparatus 423.

The first sub-apparatus 422 and the second sub-apparatus 423 are apparatuses that communicate with the main apparatus 421.

For example, the main apparatus 421 is an apparatus called a human machine interface (HMI).

For example, the each sub-apparatus (422, 423) is an apparatus called a programmable logic controller (PLC).

The state replication system 100 includes a state replication apparatus 200, a proxy response apparatus 300, and a target operation apparatus 400.

The state replication apparatus 200, the proxy response apparatus 300, and the target operation apparatus 400 communicate with each other via a communication channel 101.

The target operation apparatus 400 runs the main apparatus 421, the first sub-apparatus 422, and the second sub-apparatus 423.

In specific, the target operation apparatus 400 runs a first virtual computer 411 as the main apparatus 421, runs a second virtual computer 412 as the first sub-apparatus 422, and runs a third virtual computer 413 as the second sub-apparatus 423.

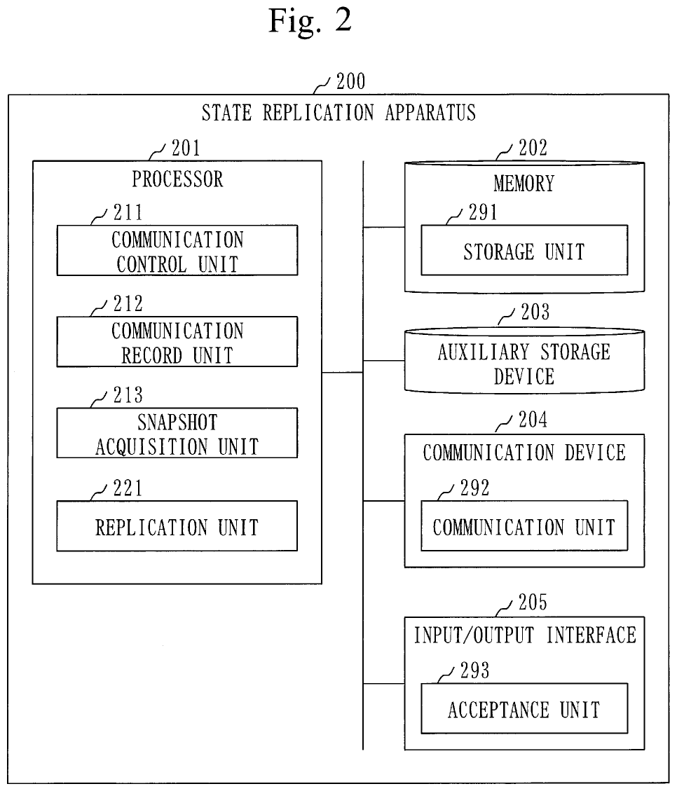

Based on FIG. 2, a configuration of the state replication apparatus 200 will be explained.

The state replication apparatus 200 is a computer that includes hardware, such as a processor 201, a memory 202, an auxiliary storage device 203, a communication device 204, and an input/output interface 205. These hardware are connected to each other via a signal line.

The processor 201 is an integrated circuit (IC) that performs an arithmetic processing, and controls the other hardware. For example, the processor 201 is a central processing unit (CPU), a digital signal processor (DSP), or a graphics processing unit (GPU).

The memory 202 is a volatile storage device. The memory 202 is called also a main storage device or a main memory. For example, the memory 202 is a random access memory (RAM). Data stored in the memory 202 is kept, as necessary, in the auxiliary storage device 203.

The auxiliary storage device 203 is a nonvolatile storage device. For example, the auxiliary storage device 203 is a read only memory (ROM), a hard disk drive (HDD), or a flash memory. Data stored in the auxiliary storage device 203 is loaded, as necessary, in the memory 202.

The communication device 204 is a device that carries out communication, that is, a receiver and a transmitter. For example, the communication device 204 is a communication chip or a network interface card (NIC).

The input/output interface 205 is a port to which an input device and an output device are connected. For example, the input/output interface 205 is a USB terminal, the input devices are a keyboard and a mouse, and the output device is a display. USB is an abbreviation for Universal Serial Bus.

The state replication apparatus 200 includes components, such as a communication control unit 211, a communication record unit 212, a snapshot acquisition unit 213, and a replication unit 221. These components are realized by software.

In the auxiliary storage device 203, a state replication program for causing a computer to function as the communication control unit 211, the snapshot acquisition unit 213, and the replication unit 221 is stored. The state replication program is loaded in the memory 202, and executed by the processor 201.

Further, in the auxiliary storage device 203, an operating system (OS) is stored. At least a part of the OS is loaded in the memory 202, and executed by the processor 201.

In other words, the processor 201 executes the state replication program while executing the OS.

Data that is acquired by executing the state replication program is stored in a storage device, such as the memory 202, the auxiliary storage device 203, a register within the processor 201, or a cache memory within the processor 201.

The memory 202 functions as a storage unit 291 that stores the data. However, any of the other storage devices may function as the storage unit 291 instead of the memory 202, or together with the memory 202.

The communication device 204 functions as a communication unit 292 that communicates the data. The data that is transmitted and received by the state replication apparatus 200 is transmitted and received via the communication unit 292.

The input/output interface 205 functions as an acceptance unit 293 that accepts an input.

The state replication apparatus 200 may include a plurality of processors that substitute the processor 201. The plurality of processors divide a role of the processor 201 among the plurality of processors.

The state replication program may be recorded (stored) in a computer-readable way in a nonvolatile storage medium, such as an optical disc or a flash memory.

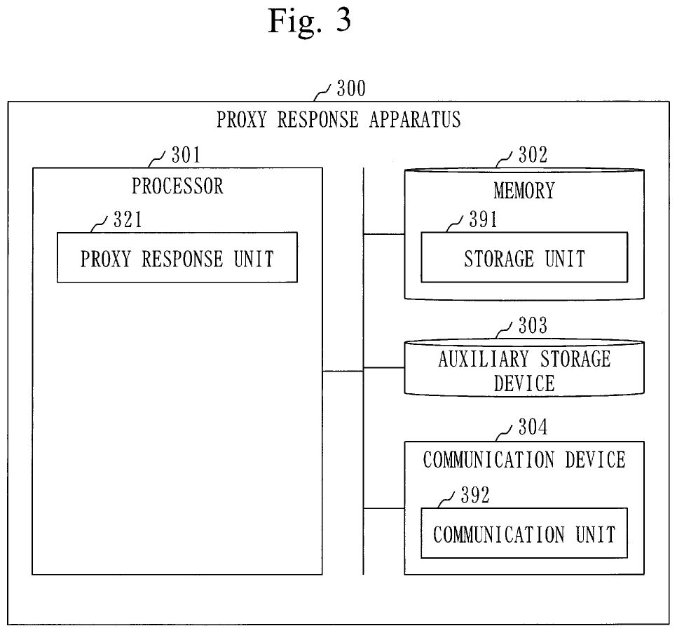

Based on FIG. 3, a configuration of the proxy response apparatus 300 will be explained.

The proxy response apparatus 300 is a computer that includes hardware, such as a processor 301, a memory 302, an auxiliary storage device 303, and a communication device 304. These hardware are connected to each other via a signal line.

The processor 301 is an IC that performs an arithmetic processing, and controls the other hardware. For example, the processor 301 is a CPU, a DSP, or a GPU.

The memory 302 is a volatile storage device. The memory 302 is called also a main storage device or a main memory. For example, the memory 302 is a RAM. Data stored in the memory 302 is kept, as necessary, in the auxiliary storage device 303.

The auxiliary storage device 303 is a nonvolatile storage device. For example, the auxiliary storage device 303 is a ROM, an HDD, or a flash memory. The data stored in the auxiliary storage device 303 is loaded, as necessary, in the memory 302.

The communication device 304 is a device that carries out communication, that is, a receiver and a transmitter. For example, the communication device 304 is a communication chip or an NIC.

The proxy response apparatus 300 includes a proxy response unit 321. The proxy response unit 321 is realized by software.

In the auxiliary storage device 303, a proxy response program for causing a computer to function as the proxy response unit 321 is stored. The proxy response program is loaded in the memory 302, and executed by the processor 301.

Further, in the auxiliary storage device 303, an OS is stored. At least a part of the OS is loaded in the memory 302, and executed by the processor 301.

In other words, the processor 301 executes the proxy response program while executing the OS.

Data that is acquired by executing the proxy response program is stored in a storage device, such as the memory 302, the auxiliary storage device 303, a register within the processor 301, or a cache memory within the processor 301.

The memory 302 functions as a storage unit 391 that stores the data. However, any of the other storage devices may function as the storage unit 391 instead of the memory 302, or together with the memory 302.

The communication device 304 functions as a communication unit 392 that communicates the data. The data that is transmitted and received by the proxy response apparatus 300 is transmitted and received via the communication unit 392.

The proxy response apparatus 300 may include a plurality of processors that substitute the processor 301. The plurality of processors divide a role of the processor 301 among the plurality of processors.

The proxy response program may be recorded (stored) in a computer-readable way in a nonvolatile storage medium, such as an optical disc or a flash memory.

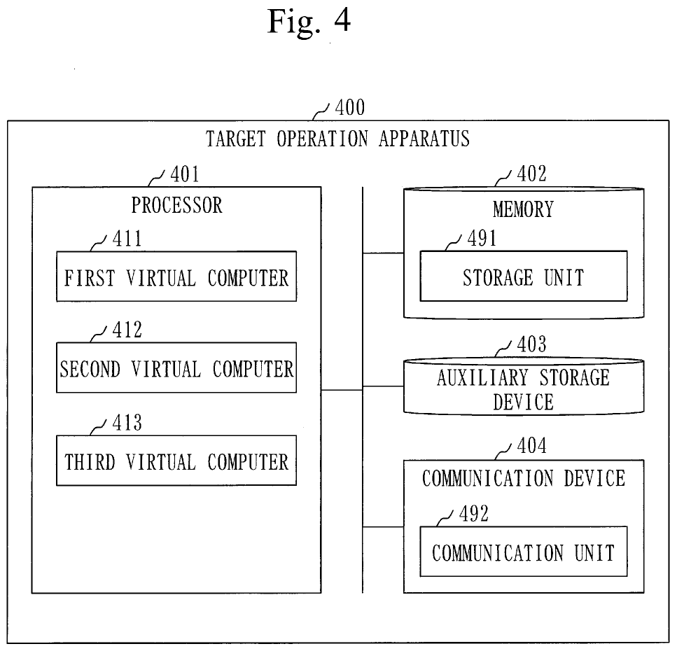

Based on FIG. 4, a configuration of the target operation apparatus 400 will be explained.

The target operation apparatus 400 is a computer that includes hardware, such as a processor 401, a memory 402, an auxiliary storage device 403, and a communication device 404. These hardware are connected to each other via a signal line.

The processor 401 is an IC that performs an arithmetic processing, and controls the other hardware. For example, the processor 401 is a CPU, a DSP, or a GPU.

The memory 402 is a volatile storage device. The memory 402 is called also a main storage device or a main memory. For example, the memory 402 is a RAM. Data stored in the memory 402 is kept, as necessary, in the auxiliary storage device 403.

The auxiliary storage device 403 is a nonvolatile storage device. For example, the auxiliary storage device 403 is a ROM, an HDD, or a flash memory. The data stored in the auxiliary storage device 403 is loaded, as necessary, in the memory 402.

The communication device 404 is a device that carries out communication, that is, a receiver and a transmitter. For example, the communication device 404 is a communication chip or an NIC.

The target operation apparatus 400 includes components, such as the first virtual computer 411, the second virtual computer 412, and the third virtual computer 413. These components are realized by software.

In the auxiliary storage device 403, a target operation program for causing a computer to function as the first virtual computer 411, the second virtual computer 412, and the third virtual computer 413 is stored. The target operation program is loaded in the memory 402, and executed by the processor 401.

Further, in the auxiliary storage device 403, an OS is stored. At least a part of the OS is loaded in the memory 402, and executed by the processor 401.

In other words, the processor 401 executes the target operation program while executing the OS.

Data that is acquired by executing the target operation program is stored in a storage device, such as the memory 402, the auxiliary storage device 403, a register within the processor 401, or a cache memory within the processor 401.

The memory 402 functions as a storage unit 491 that stores the data. However, any of the other storage devices may function as the storage unit 491 instead of the memory 402, or together with the memory 402.

The communication device 404 functions as a communication unit 492 that communicates the data. The data that is transmitted and received by the target operation apparatus 400 is transmitted and received via the communication unit 492.

The target operation apparatus 400 may include a plurality of processors that substitute the processor 401. The plurality of processors divide a role of the processor 401 among the plurality of processors.

The target operation program may be recorded (stored) in a computer-readable way in a nonvolatile storage medium, such as an optical disc or a flash memory.

*** Description of Operation ***

Operation of the state replication system 100 is equivalent to a state replication method. And, a procedure of the state replication method is equivalent to a procedure of the state replication program.

The state replication program may be recorded (stored) in a computer-readable way in a nonvolatile storage medium, such as an optical disc or a flash memory.

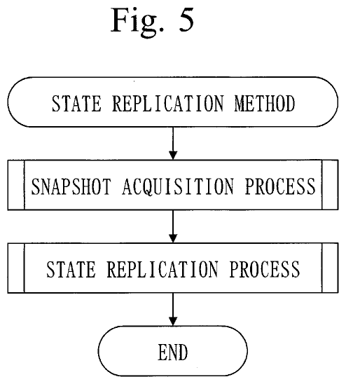

Based on FIG. 5, the state replication method will be explained.

First, a snapshot acquisition process is executed.

After that, a state replication process is executed.

A summary of the snapshot acquisition process will be explained.

In the snapshot acquisition process, an acquisition scenario is executed.

The acquisition scenario is created by a user, and stored in the storage unit 291 of the state replication apparatus 200 in advance.

In the acquisition scenario, transition order and a plurality of acquisition timings are specified.

The transition order is order in accordance with which a state combination is caused to transit.

The state combination is a combination of a state of the main apparatus 421 and a state of the each sub-apparatus (422, 423).

The acquisition timing is a timing at which a snapshot combination is acquired.

The snapshot combination is a combination of a snapshot of the main apparatus 421 and a snapshot of the each sub-apparatus (422, 423).

In the snapshot acquisition process, the state replication system 100 operates as set out below.

The communication control unit 211 generates communication, between the main apparatus 421 and the each sub-apparatus, to cause the state combination to transit in accordance with the transition order specified in the acquisition scenario.

The communication record unit 212 records each of the communication that has been generated between the main apparatus 421 and the each sub-apparatus.

The snapshot acquisition unit 213 acquires the snapshot combination at each of the acquisition timings specified in the acquisition scenario.

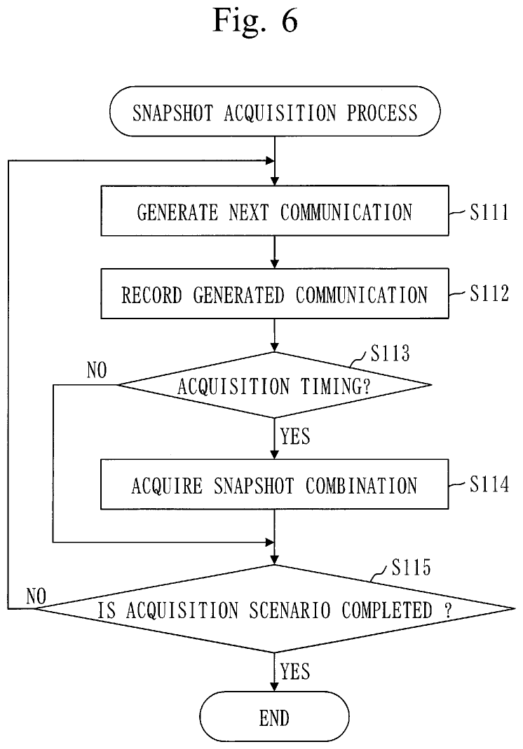

Based on FIG. 6, a procedure of the snapshot acquisition process will be explained.

In step S111, the communication control unit 211 refers to the acquisition scenario, and generates next communication.

In specific, the communication control unit 211 generates the next communication as set out below.

The acquisition scenario presents a state combination and a state transition instruction in the transition order of the state combination. The state transition instruction is an instruction to cause the state combination to transit.

The communication control unit 211 chooses a next state transition instruction in the transition order of the state combination, and transmits the next state transition instruction to the main apparatus 421.

The main apparatus 421 receives the next state transition instruction, and, in accordance with the next state transition instruction, transmits a communication packet to the each sub-apparatus. The each sub-apparatus receives the communication packet from the main apparatus 421, and transmits a response communication packet to the main apparatus 421. The main apparatus 421 receives the response communication packet.

In step S112, the communication record unit 212 records the communication that has been generated.

In specific, the communication record unit 212 records the communication as set out below.

When the communication is generated, the communication packet flows in the communication channel 101.

The communication record unit 212 captures the each communication packet flowing in the communication channel 101, and records, in a Communication table, contents of the each communication packet captured, relating them to the state combination and the state transition instruction.

The communication table is a table illustrating, in the transition order of the state combination, the state combination, the state transition instruction, and the contents of input and output of the communication packet in the main apparatus 421, relating them to each other. The communication table is stored in the storage unit 291.

In the main apparatus 421, a communication packet to be an output is a communication packet from the main apparatus 421 to the each sub-apparatus.

In the main apparatus 421, a communication packet to be an input is a communication packet from the each sub-apparatus to the main apparatus 421.

In step S113, the snapshot acquisition unit 213 refers to the acquisition scenario, and determines whether it is an acquisition timing.

If it is the acquisition timing, processing proceeds to step S114.

If it is not the acquisition timing, the processing proceeds to step S115.

In step S114, the snapshot acquisition unit 213 acquires a snapshot combination.

In specific, the snapshot acquisition unit 213 acquires the snapshot combination as set out below.

In the acquisition scenario, for each of the acquisition timings, a virtual computer combination is specified. The virtual computer combination is a combination of the virtual computers (411, 412, 413).

The snapshot acquisition unit 213 refers to the acquisition scenario, chooses the virtual computer combination that corresponds to the acquisition timing, and requests each of the virtual computers of the chosen virtual computer combination to acquire a snapshot.

Then, each of the virtual computers of the request destinations acquires the snapshot, and stores, in the storage unit 491, the acquired snapshot.

If the virtual computer of the request destination is the first virtual computer 411, the first virtual computer 411 acquires a snapshot of the main apparatus 421, and stores, in the storage unit 491, the acquired snapshot.

If the virtual computer of the request destination is the second virtual computer 412, the second virtual computer 412 acquires a snapshot of the first sub-apparatus 422, and stores, in the storage unit 491, the acquired snapshot.

If the virtual computer of the request destination is the third virtual computer 413, the third virtual computer 413 acquires a snapshot of the second sub-apparatus 423, and stores, in the storage unit 491, the acquired snapshot.

In step S115, the communication control unit 211 determines whether the acquisition scenario is completed.

If the acquisition scenario is not completed, the processing proceeds to step S111.

If the acquisition scenario is completed, the processing ends.

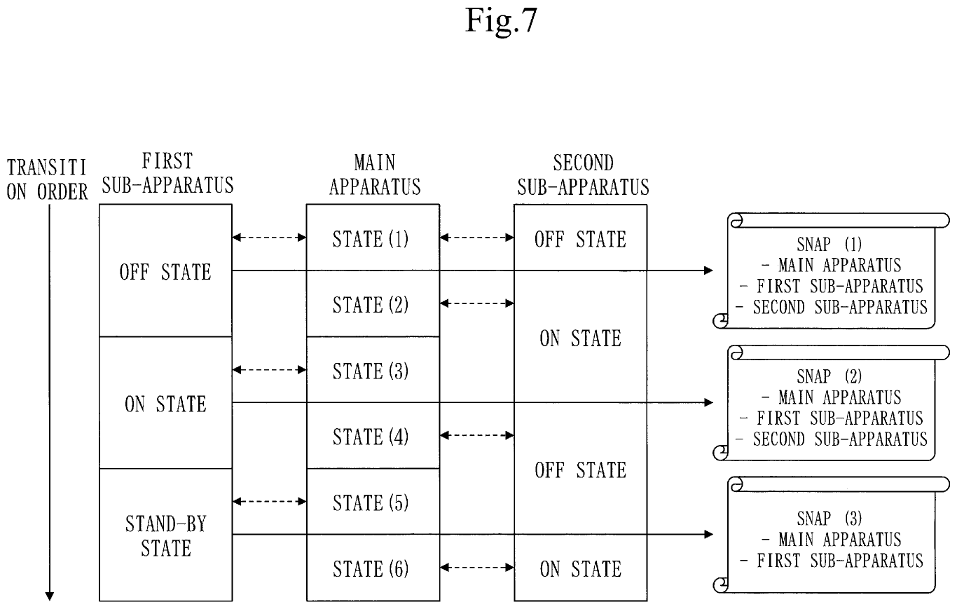

Based on FIG. 7, an example of the snapshot acquisition process will be explained.

For example, in the acquisition scenario, contents illustrated in FIG. 7 are stated.

The main apparatus 421 has six states of state from (1) to (6).

The first sub-apparatus 422 has three states of an off state, an on state, and a stand-by state.

The second sub-apparatus 423 has two states of the off state and the on state.

First, the communication control unit 211 generates communication between the main apparatus 421 and the first sub-apparatus 422. The communication control unit 211 further generates communication between the main apparatus 421 and the second sub-apparatus 423. By this, the main apparatus 421 shifts to state (1), the first sub-apparatus 422 shifts to the off state, and the second sub-apparatus 423 shifts to the off state. Then, the communication record unit 212 records each of the generated communication.

Next, the snapshot acquisition unit 213 acquires a first snapshot combination (SNAP (1)). The first snapshot combination includes a snapshot of the main apparatus 421 in state (1), a snapshot of the first sub-apparatus 422 in the off state, and a snapshot of the second sub-apparatus 423 in the off state.

Next, the communication control unit 211 generates communication between the main apparatus 421 and the second sub-apparatus 423. By this, the main apparatus 421 shifts to state (2), and the second sub-apparatus 423 shifts to the on state. Then, the communication record unit 212 records the generated communication.

Next, the communication control unit 211 generates communication between the main apparatus 421 and the first sub-apparatus 422. By this, the main apparatus 421 shifts to state (3), and the first sub-apparatus 422 shifts to the on state. Then, the communication record unit 212 records the generated communication.

Next, the snapshot acquisition unit 213 acquires a second snapshot combination (SNAP (2)). The second snapshot combination includes a snapshot of the main apparatus 421 in state (3), a snapshot of the first sub-apparatus 422 in the on state, and a snapshot of the second sub-apparatus 423 in the on state.

Next, the communication control unit 211 generates communication between the main apparatus 421 and the second sub-apparatus 423. By this, the main apparatus 421 shifts to state (4), and the second sub-apparatus 423 shifts to the off state. Then, the communication record unit 212 records the generated communication.

Next, the communication control unit 211 generates communication between the main apparatus 421 and the first sub-apparatus 422. By this, the main apparatus 421 shifts to state (5), and the first sub-apparatus 422 shifts to the stand-by state. Then, the communication record unit 212 records the generated communication.

Next, the snapshot acquisition unit 213 acquires a third snapshot combination (SNAP (3)). The third snapshot combination includes a snapshot of the main apparatus 421 in state (5) and a snapshot of the first sub-apparatus 422 in the stand-by state.

Finally, the communication control unit 211 generates communication between the main apparatus 421 and the second sub-apparatus 423. By this, the main apparatus 421 shifts to state (6), and the second sub-apparatus 423 shifts to the on state. Then, the communication record unit 212 records the generated communication.

In the acquisition scenario, so as to cover all states of the each sub-apparatus, a plurality of acquisition timings are specified.

In FIG. 7, all of the three states of the first sub-apparatus 422 are covered as set out below.

The snapshot of the first sub-apparatus 422 in the off state is included in the first snapshot combination (SNAP (1)).

The snapshot of the first sub-apparatus 422 in the on state is included in the second snapshot combination (SNAP (2)).

The snapshot of the first sub-apparatus 422 in the stand-by state is included in the third snapshot combination (SNAP (3)).

In FIG. 7, all of the two states of the second sub-apparatus 423 are covered as set out below.

The snapshot of the second sub-apparatus 423 in the off state is included in the first snapshot combination (SNAP (1)).

The snapshot of the second sub-apparatus 423 in the on state is included in the second snapshot combination (SNAP (2)).

In addition, in the acquisition scenario, so as to avoid overlapping of the state of the each sub-apparatus, it is specified whether the snapshot of the each sub-apparatus is needed or not, relating it to each of the acquisition timings.

In FIG. 7, all of the two states of the second sub-apparatus 423 are covered by the first snapshot combination (SNAP (1)) and the second snapshot combination (SNAP (2)). Therefore, in the acquisition scenario, it is specified that the snapshot of the second sub-apparatus 423 does not need to be acquired at the acquisition timing of the third snapshot combination (SNAP (3)). Therefore, the third snapshot combination (SNAP (3)) does not include the snapshot of the second sub-apparatus 423.

A summary of the state replication process will be explained.

In the state replication process, each of the main apparatus 421 and the each sub-apparatus is replicated in states of a replication state combination.

The replication state combination is a state combination that is specified. The replication state combination is specified by a user, and accepted by the acceptance unit 293.

The replication unit 221 replicates, based on the acquired each snapshot combination and the recorded each communication, each of the main apparatus 421 and the each sub-apparatus in the states of the replication state combination.

When communication from the main apparatus 421 to the each sub-apparatus is generated in order to replicate the state of the main apparatus 421, the proxy response unit 321 responds to the main apparatus 421 in place of the each sub-apparatus.

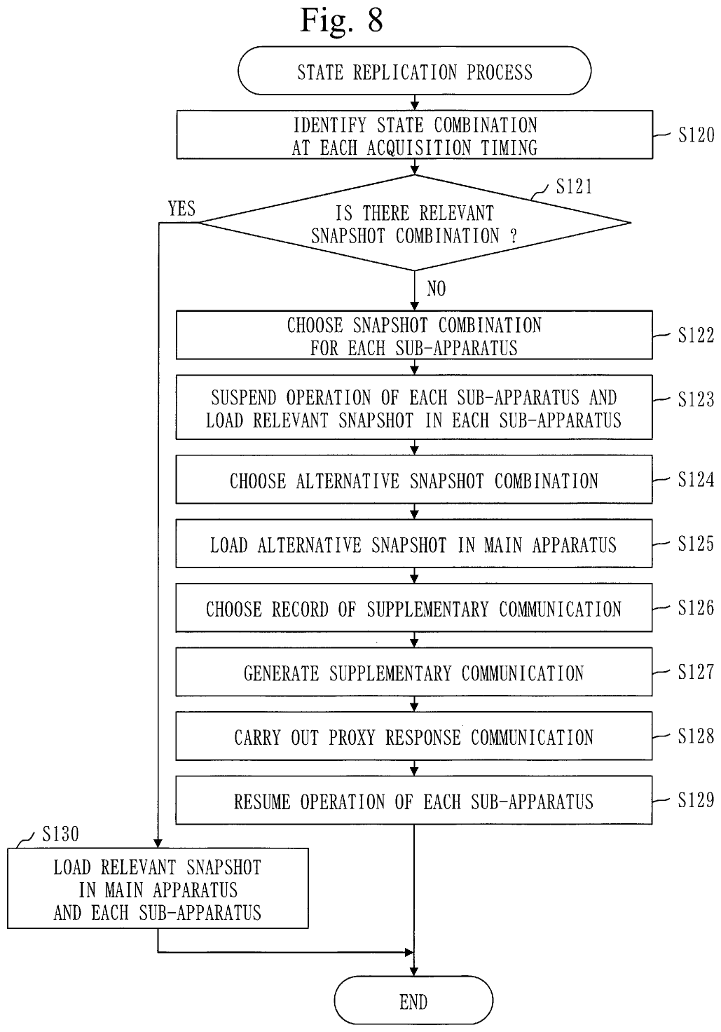

Based on FIG. 8, a procedure of the state replication process will be explained.

The communication table that has been stored in the storage unit 291 of the state replication apparatus 200 in the snapshot acquisition process mentioned above is copied in the storage unit 391 of the proxy response apparatus 300, and used in the state replication process.

In addition, before the state replication process is started, the replication state combination is accepted by the acceptance unit 293.

In step S120, the replication unit 221 refers to the acquisition scenario, and identifies a state combination for each of the acquisition timings.

In step S121, the replication unit 221 determines whether there is a relevant snapshot combination in a plurality of snapshot combinations that have been acquired in the snapshot acquisition process.

The relevant snapshot combination is a snapshot combination representing a state of the main apparatus 421 and a state of the each sub-apparatus that match those of the replication state combination.

In specific, the replication unit 221 compares the state combination at each of the acquisition timings with the replication state combination.

If a state combination at any of the acquisition timings matches the replication state combination, a snapshot combination that has been acquired at that acquisition timing is the relevant snapshot combination. In other words, in this case, there is the relevant snapshot combination.

If no state combination at any of the acquisition timings matches the replication state combination, there is not the relevant snapshot.

If there is the relevant snapshot combination, the processing proceeds to step S130.

If there is not the relevant snapshot combination, the processing proceeds to step S122.

For example, assume that, in FIG. 7, the replication state combination is a combination of state (4) for the main apparatus 421, the on state for the first sub-apparatus 422, and the off state for the second sub-apparatus 423.

In this case, the relevant snapshot combination is a snapshot combination that has been acquired when the main apparatus 421 being in state (4), the first sub-apparatus 422 being in the on state, and the second sub-apparatus 423 being in the off state.

However, when the main apparatus 421 has been in state (4), the first sub-apparatus 422 has been in the on state, and the second sub-apparatus 423 has been in the off state, there is no snapshot combination acquired.

Therefore, there is not the relevant snapshot combination.

In step S122, the replication unit 221 chooses a snapshot combination for the each sub-apparatus.

The snapshot combination for the each sub-apparatus is a snapshot combination representing a state of the each sub-apparatus that matches that of the state of the replication state combination.

In specific, the replication unit 221 compares, for each of the sub-apparatuses, a state of the sub-apparatus at each of the acquisition timings with the state of the sub-apparatus of the replication state combination.

Then, the replication unit 221 chooses, for each of the sub-apparatuses, an acquisition timing at which the state of the sub-apparatus matches the state of the replication state combination.

A snapshot combination that has been acquired at the chosen acquisition timing is the snapshot combination for the sub-apparatus.

For example, assume that, in FIG. 7, a state of the first sub-apparatus 422 of the replication state combination is the on state. In this case, a snapshot combination for the first sub-apparatus 422 is the second snapshot combination (SNAP (2)).

For example, assume that, in FIG. 7, a state of the second sub-apparatus 423 of the replication state combination is the off state. In this case, a snapshot combination for the second sub-apparatus 423 is the first snapshot combination (SNAP (1)).

In step S123, the replication unit 221, suspends operation of the each sub-apparatus, and loads the relevant snapshot in the each sub-apparatus.

While being suspended, no communication is carried out by the each sub-apparatus.

The relevant snapshot of the sub-apparatus is a snapshot of the sub-apparatus included in the snapshot combination for the sub-apparatus.

In specific, the replication unit 221 transmits, for each of the sub-apparatuses, a suspension instruction and a load instruction, in order, to a virtual computer. The load instruction specifies an acquisition timing at which the snapshot combination for the sub-apparatus has been acquired.

Each virtual computer receives the suspension instruction, and suspends the operation of the sub-apparatus. Next, the each virtual computer receives the load instruction. The each virtual computer chooses, from the plurality of snapshots that have been acquired in the snapshot acquisition process, a snapshot that has been acquired at the acquisition timing specified in the load instruction. Then, the each virtual computer loads the chosen snapshot in a storage area for the sub-apparatus.

In other words, the replication unit 221 transmits, to the second virtual computer 412, a load instruction in which the acquisition timing at which the snapshot combination for the first sub-apparatus 422 has been acquired is specified. The second virtual computer 412 suspends the first sub-apparatus 422, chooses a snapshot that has been acquired at the acquisition timing specified in the load instruction, and loads the chosen snapshot in a storage area for the first sub-apparatus 422.

For example, assume that, in FIG. 7, the snapshot combination for the first sub-apparatus 422 is the second snapshot combination (SNAP (2)).

In this case, the replication unit 221 transmits, to the second virtual computer 412, a load instruction in which the acquisition timing for the second snapshot combination is specified. Then, the second virtual computer 412 suspends the first sub-apparatus 422, and loads a snapshot of the first sub-apparatus 422 included in the second snapshot combination in the storage area for the first sub-apparatus 422.

The replication unit 221 also transmits, to the third virtual computer 413, a load instruction in which the acquisition timing at which the snapshot combination for the second sub-apparatus 423 has been acquired is specified. The third virtual computer 413 suspends the second sub-apparatus 423, chooses a snapshot that has been acquired at the acquisition timing specified in the load instruction, and loads the chosen snapshot in a storage area for the second sub-apparatus 423.

For example, assume that, in FIG. 7, the snapshot combination for the second sub-apparatus 423 is the first snapshot combination (SNAP (1)).

In this case, the replication unit 221 transmits, to the third virtual computer 413, a load instruction in which the acquisition timing for the first snapshot combination is specified. Then, the third virtual computer 413 suspends the second sub-apparatus 423, and loads the snapshot of the second sub-apparatus 423 included in the first snapshot combination in the storage area for the second sub-apparatus 423.

In step S124, the replication unit 221 chooses an alternative snapshot combination.

The alternative snapshot combination is any of the snapshot combinations.

For example, the replication unit 221 refers to the acquisition scenario, and chooses an acquisition timing immediately before the state of the main apparatus 421 transits to the state of the replication state combination.

This preceding acquisition timing is an acquisition timing that is closest to a time when the state of the main apparatus 421 transits to the state of the replication state combination among acquisition timings at or before which the state of the main apparatus 421 transits to the state of the replication state combination.

A snapshot combination that has been acquired at the acquisition timing of this straight line is the alternative snapshot combination.

For example, assume that, in FIG. 7, the state of the main apparatus 421 of the replication state combination is state (4).

In this case, the acquisition timing of this straight line at which the state of the main apparatus 421 transits to state (4) is the acquisition timing of the second snapshot combination (SNAP (2)).

In other words, the alternative snapshot combination is the second snapshot combination.

In step S125, the replication unit 221 loads the alternative snapshot in the main apparatus 421.

The alternative snapshot is a snapshot of the main apparatus 421 included in the alternative snapshot combination.

In specific, the replication unit 221 transmits, to the first virtual computer 411, a load instruction in which the acquisition timing of the alternative snapshot combination is specified. The first virtual computer 411 chooses a snapshot that has been acquired at the acquisition timing specified in the load instruction, and loads the chosen snapshot in a storage area for the main apparatus 421.

For example, assume that, in FIG. 7, the alternative snapshot combination is the second snapshot combination (SNAP (2)).

In this case, the replication unit 221 transmits, to the first virtual computer 411, a load instruction in which the acquisition timing for the second snapshot combination is specified. And, the first virtual computer 411 loads a snapshot of the main apparatus 421 included in the second snapshot combination in the storage area for the main apparatus 421.

In step S126, the replication unit 221 chooses a record of supplementary communication from the communication record that has been acquired in the snapshot acquisition process.

The supplementary communication is communication that has been generated from a time when the alternative snapshot combination has been acquired until a time when the state of the main apparatus 421 matches the state of the replication state combination.

In specific, the replication unit 221 chooses the record of the supplementary communication from the communication table that has been generated in the snapshot acquisition process.

For example, assume that, in FIG. 7, the alternative snapshot combination is the second snapshot combination (SNAP (2)), and the state of the main apparatus 421 of the replication state combination is state (4).

In this case, the supplementary communication is communication that has been generated between the main apparatus 421 and the second sub-apparatus 423 from the acquisition timing for the second snapshot combination until the time when the main apparatus 421 turns to state (4).

In step S127, the replication unit 221 causes the main apparatus 421 to generate the supplementary communication in accordance with the chosen record.

In specific, the replication unit 221 chooses, from the communication table, a state transition instruction having been related to the chosen record, and transmits the chosen state transition instruction to the main apparatus 421. The main apparatus 421 receives the state transition instruction, and transmits a communication packet to the each sub-apparatus in accordance with the state transition instruction.

Since the each sub-apparatus is suspended when the relevant snapshot is loaded, the each sub-apparatus does not receive the communication packet. Therefore, the each sub-apparatus does not transmit a response communication packet to the main apparatus 421.

In step S128, the proxy response unit 321 carries out proxy response communication with the main apparatus 421.

The proxy communication response is supplementary communication that is carried out with the main apparatus 421, in place of the each sub-apparatus.

In specific, the proxy response unit 321 carries out the proxy response communication as set out below.

First, the proxy response unit 321 receives the communication packet from the main apparatus 421.

Next, the proxy response unit 321 chooses, from the communication table, a communication packet that is equivalent to the received communication packet.

Next, the proxy response unit 321 chooses, from the communication table, a response communication packet that corresponds to the chosen communication packet.

Then, the proxy response unit 321 transmits, to the main apparatus 421, a communication packet that is equivalent to the chosen response communication packet.

The main apparatus 421 receives the communication packet from the proxy response unit 321 as a communication packet from the sub-apparatus.

By the proxy response communication being carried out, the state of the main apparatus 421 transits to the state of the replication state combination.

As a result of this, each of the main apparatus 421 and the each sub-apparatus is replicated in the states of the replication state combination.

In step S129, the replication unit 221 resumes the operation of the each sub-apparatus.

In specific, the replication unit 221, for each of the sub-apparatuses, transmits a resumption instruction to the virtual computer. The each virtual computer receives the resumption instruction, and resumes the operation of the sub-apparatus.

In step S130, the replication unit 221 loads the relevant snapshot in the main apparatus 421 and the each sub-apparatus. A loading method is same as steps S123 and S125. The each sub-apparatus does not need to be suspended.

The relevant snapshot is a snapshot included in the relevant snapshot combination.

Unless the relevant snapshot combination includes a snapshot of either of the sub-apparatuses, the replication unit 221 loads the relevant snapshot in that sub-apparatus by a method that is same as steps S122 and S123.

*** Advantageous Effect of Embodiment 1 ***

In Embodiment 1, one snapshot is acquired per the each sub-apparatus for a state of the each sub-apparatus. A snapshot of the main apparatus 421 is acquired at a same timing as that of the snapshot of the each sub-apparatus. Further, in order to supplement a shortage of the snapshot of the main apparatus 421, communication generated between the main apparatus 421 and the each sub-apparatus is recorded.

This enables replication of each of the main apparatus 421 and the each sub-apparatus in states of a replication state combination while reducing the number of snapshots.

*** Other Configurations ***

If a snapshot combination is acquired at a last acquisition timing (S114) in a snapshot acquisition process (see FIG. 6), the communication control unit 211, the communication record unit 212, and the snapshot acquisition unit 213 may end processing even if an acquisition scenario is not completed.

For example, in FIG. 7, at a point of time when a third snapshot combination (SNAP (3)) is acquired, the snapshot acquisition process may be ended. In other words, the main apparatus 421 does not need to be transited to state (6).

Each component of the state replication apparatus 200 and the proxy response apparatus 300 may be mounted all together in one apparatus, or may be divided into and mounted in three or more apparatuses.

The main apparatus 421 and the each sub-apparatus may be realized by a real-life computer, without being realized by a virtual computer.

The number of sub-apparatuses may be three or more.

### Embodiment 2

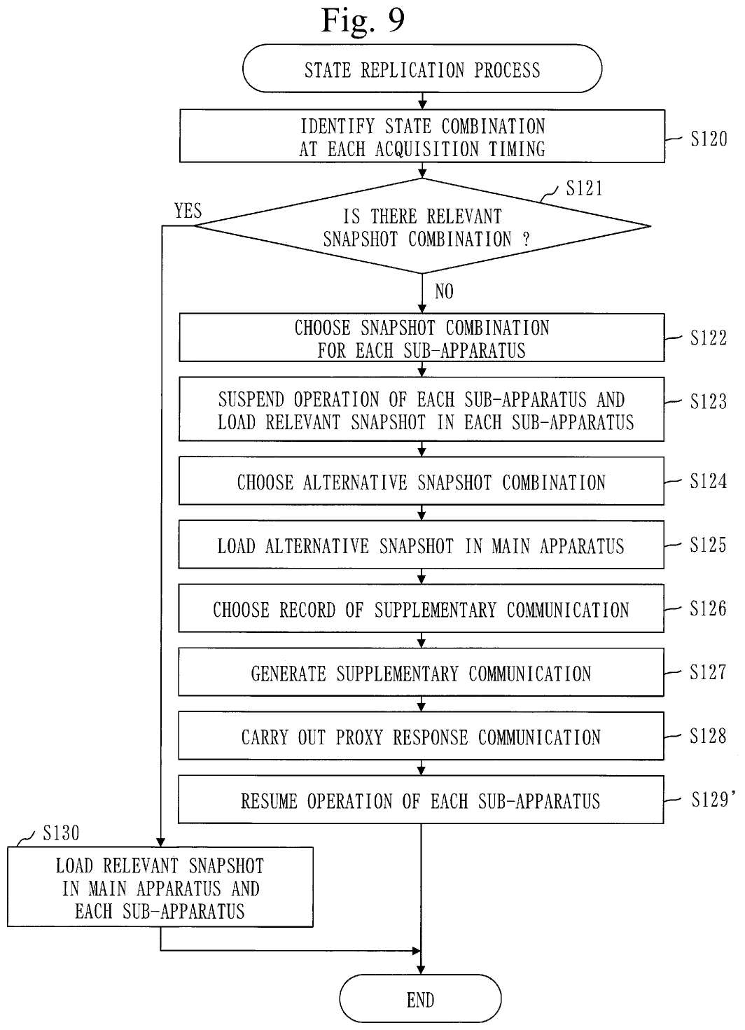

As to an embodiment to prevent mismatching of session IDs (identifiers) due to proxy response communication, mainly differences from Embodiment 1 will be explained based on FIG. 9.

*** Description of Configuration ***

A configuration of the state replication system 100 is same as a configuration according to Embodiment 1 (see FIGS. 1 to 4).

*** Description of Operation ***

A procedure of a state replication method is same as a procedure according to Embodiment 1 (see FIG. 5).

A procedure of a snapshot acquisition process is same as a procedure according to Embodiment 1 (see FIG. 6).

Based on FIG. 9, a procedure of a state replication process will be explained.

Steps from S120 to S128 and S130 are as explained in Embodiment 1 (See FIG. 8).

In step S129′, the replication unit 221 disconnects a session between the main apparatus 421 and the each sub-apparatus.

In specific, the replication unit 221 transmits a disconnection instruction to the main apparatus 421. The main apparatus 421 receives the disconnection instruction, and disconnects the session with the each sub-apparatus. For example, the main apparatus 421 transmits a FIN packet in a transmission control protocol (TCP) to the each sub-apparatus.

After that, the replication unit 221, in a same way as step S129 in Embodiment 1 (see FIG. 8), resumes operation of the each sub-apparatus.

*** Advantageous Effect of Embodiment 2 ***

In Embodiment 2, after a state of the main apparatus 421 is replicated by proxy response communication, and before operation of each sub-apparatus is resumed, a session between the main apparatus 421 and the each sub-apparatus is disconnected.

As a result of this, when the main apparatus 421 communicates with the each sub-apparatus, a new session is established between the main apparatus 421 and the each sub-apparatus.

By this, even if session IDs of the main apparatus 421 and the each sub-apparatus do not match as a result that the proxy response communication has been carried out, mismatching of the session IDs may be resolved.

In other words, the mismatching of the session IDs may be prevented. And, this enables more precise replication of states of the main apparatus 421 and the each sub-apparatus.

### Embodiment 3

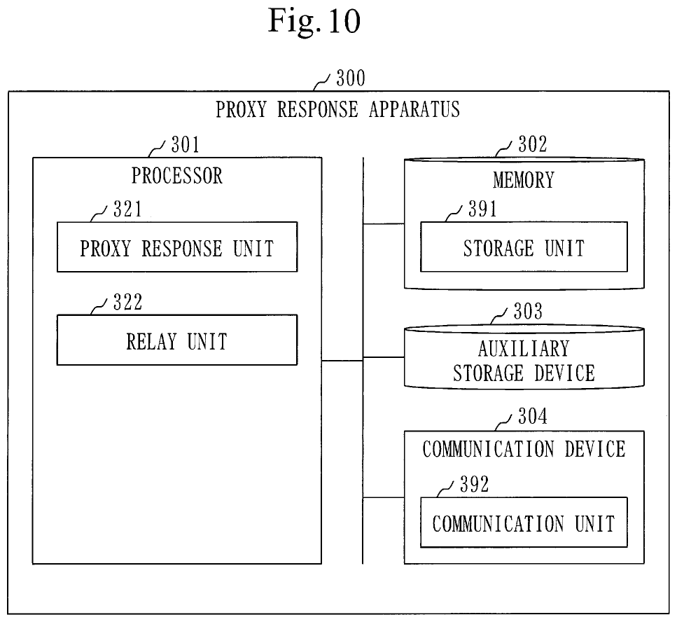

As to an embodiment to prevent mismatching of communication sequence numbers due to proxy response communication, mainly differences from Embodiment 1 will be explained based on FIG. 10.

The communication sequence number is equivalent to a session ID in a TCP.

*** Description of Configuration ***

A configuration of the state replication system 100 is same as a configuration according to Embodiment 1 (see FIG. 1).

A configuration of the state replication apparatus 200 is same as a configuration according to Embodiment 1 (see FIG. 2).

A configuration of the target operation apparatus 400 is same as a configuration according to Embodiment 1 (see FIG. 4).

Based on FIG. 10, a configuration of the proxy response apparatus 300 will be explained.

The proxy response apparatus 300 further includes a relay unit 322. The relay unit 322 is realized by software.

A proxy response program further causes a computer to function as the relay unit 322.

*** Description of Operation ***

A procedure of a state replication method is same as a procedure according to Embodiment 1 (see FIGS. 5, 6, and 8).

If communication is generated between the main apparatus 421 and the each apparatus after each of the main apparatus 421 and the each sub-apparatus is replicated in states of a replication state combination (or after operation of the each sub-apparatus is resumed), the relay unit 322 operates as set out below.

The relay unit 322 rewrites a sequence number included in each communication packet that is communicated between the main apparatus 421 and the each sub-apparatus, and then relays the each communication packet.

In specific, the relay units 322 receives the communication packet that is transmitted from the main apparatus 421, appropriately rewrites the sequence number included in the received communication packet, and transmits, to the each apparatus, the communication packet after rewriting. In other words, the relay unit 322 decides a sequence number based on a sequence number included in a previous communication packet from the each sub-apparatus. Then, the relay unit 322 rewrites the sequence number included in the current communication packet from the main apparatus 421 to the decided sequence number.

The relay unit 322 also receives a communication packet transmitted from the each sub-apparatus, appropriately rewrites a sequence number included in the received communication packet, and transmits, to the main apparatus 421, the communication packet after rewriting. In other words, the relay unit 322 decides a sequence number based on a sequence number included in a previous communication packet from the main apparatus 421. Then, the relay unit 322 rewrites the sequence number included in the current communication packet from the each sub-apparatus to the decided sequence number.

As a result of this, the sequence numbers matches in a plurality of communication packets that are communicated between the main apparatus 421 and the each sub-apparatus via the relay unit 322.

*** Advantageous Effect of Embodiment 3 ***

In Embodiment 3, if, after each of the main apparatus 421 and the each sub-apparatus having been replicated in states of a replication state combination, communication is generated between the main apparatus 421 and the each sub-apparatus, the relay unit 322, by appropriately rewriting a sequence number included in a communication packet, relays the communication between the main apparatus 421 and the each sub-apparatus.

Even if, as a result that a proxy response communication has been carried out, the sequence numbers of the main apparatus 421 and the each sub-apparatus fail to match, the mismatching of the sequence numbers may be resolved by this.

In other words, the mismatching of the sequence numbers may be prevented. And, this enables more precise replication of states of the main apparatus 421 and the each sub-apparatus.

*** Other Configuration ***

Embodiment 3 may be implemented by a combination with Embodiment 2.

In other words, in Embodiment 3, a session between the main apparatus 421 and the each apparatus may be disconnected after the main apparatus 421 is replicated in a state of a replication state combination by a proxy response communication and before operation of the each apparatus is resumed.

### Embodiment 4

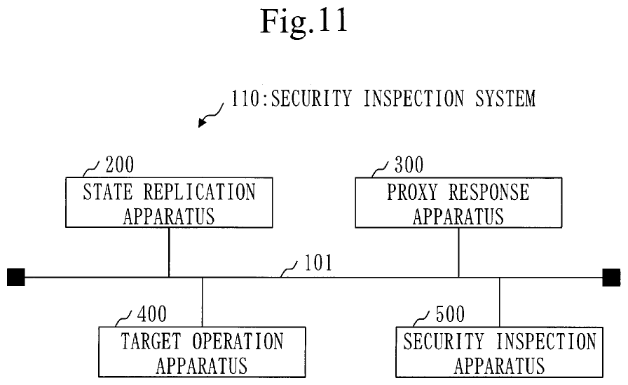

As to a security inspection system 110, mainly differences from Embodiments from 1 to 3 will be explained based on FIGS. 11 to 13.

*** Description of Configuration ***

Based on FIG. 11, a configuration of the security inspection system 110 will be explained.

The security inspection system 110 includes the state replication apparatus 200, the proxy response apparatus 300, the target operation apparatus 400, and a security inspection apparatus 500.

In other words, the security inspection system 110 includes the security inspection apparatus 500 in addition to components of the state replication system 100.

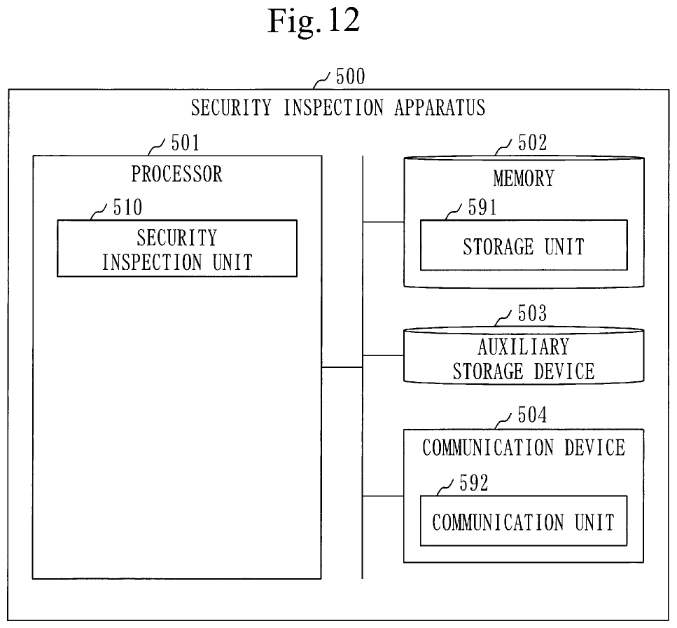

Based on FIG. 12, a configuration of the security inspection apparatus 500 will be explained.

The security inspection apparatus 500 is a computer that includes hardware, such as a processor 501, a memory 502, an auxiliary storage device 503, and a communication device 504. These hardware are connected to each other via a signal line.

The processor 501 is an IC that performs an arithmetic processing, and controls the other hardware. For example, the processor 501 is a CPU, a DSP, or a GPU.

The memory 502 is a volatile storage device. The memory 502 is called also a main storage device or a main memory. For example, the memory 502 is a RAM. Data stored in the memory 502 is kept, as necessary, in the auxiliary storage device 503.

The auxiliary storage device 503 is a nonvolatile storage device. For example, the auxiliary storage device 503 is a ROM, an HDD, or a flash memory. Data stored in the auxiliary storage device 503 is loaded, as necessary, in the memory 502.

The communication device 504 is a device that carries out communication, that is, a receiver and a transmitter. For example, the communication device 504 is a communication chip or an NIC.

The security inspection apparatus 500 includes a security inspection unit 510. The security inspection unit 510 is realized by software.

In the auxiliary storage device 503, a security inspection program for causing a computer to function as the security inspection unit 510 is stored. The security inspection program is loaded in the memory 502, and executed by the processor 501.

Further, in the auxiliary storage device 503, an OS is stored. At least a part of the OS is loaded in the memory 502, and executed by the processor 501.

In other words, the processor 501 executes the security inspection program while executing the OS.

Data that is acquired by executing the security inspection program is stored in a storage device, such as the memory 502, the auxiliary storage device 503, a register within the processor 501, or a cache memory within the processor 501.

The memory 502 functions as a storage unit 591 that stores the data. However, any of the other storage devices may function as the storage unit 591 instead of the memory 502, or together with the memory 502.

The communication device 504 functions as a communication unit 592 that communicates the data. The data that is transmitted and received by the security inspection apparatus 500 is transmitted and received via the communication unit 592.

The security inspection apparatus 500 may include a plurality of processors that substitute the processor 501. The plurality of processors divide a role of the processor 501 among the plurality of processors.

The security inspection program may be recorded (stored) in a computer-readable way in a nonvolatile storage medium, such as an optical disc or a flash memory.

*** Description of Operation ***

Operation of the security inspection system 110 is equivalent to a security inspection method. And, a procedure of the security inspection method is equivalent to a procedure of a security inspection program.

The security inspection program may be recorded (stored) in a computer-readable way in a nonvolatile storage medium, such as an optical disc or a flash memory.

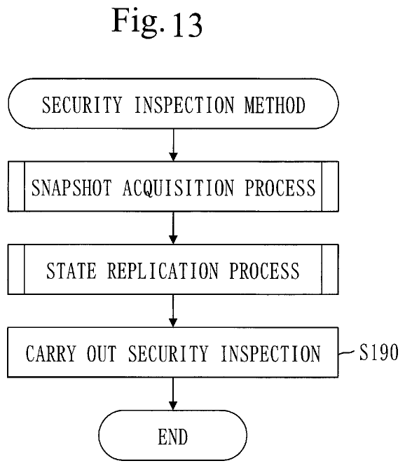

Based on FIG. 13, the security inspection method will be explained.

A snapshot acquisition process and a state replication process are as explained in Embodiments from 1 to 3.

After the state replication process, step S190 is executed.

In step S190, the security inspection unit 510 carries out a security inspection of the main apparatus 421 and each sub-apparatus.

In specific, the security inspection unit 510 carries out a penetration test of the main apparatus 421 and the each sub-apparatus.

A method to carry out the penetration test or a security inspection other than the penetration test is same as a conventional method.

*** Advantageous Effect of Embodiment 4 ***

After each of the main apparatus 421 and the each sub-apparatus is replicated in states of a replication state combination in a snapshot acquisition process and a state replication process, a security inspection of the main apparatus 421 and the each sub-apparatus may be carried out. In other words, the security inspection may be carried out for the main apparatus 421 and the each sub-apparatus in the state of the replication state combination.

*** Supplement to Embodiments ***

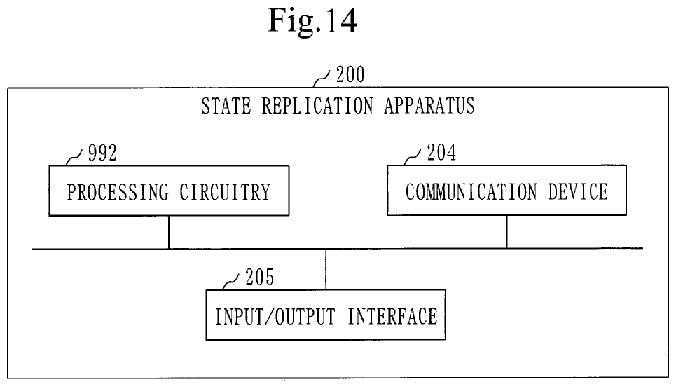

Based on FIG. 14, a hardware configuration of the state replication apparatus 200 will be explained.

The state replication apparatus 200 includes a processing circuitry 992.

The processing circuitry 992 is hardware that realizes the communication control unit 211, the communication record unit 212, the snapshot acquisition unit 213, the replication unit 221, and the storage unit 291.

The processing circuitry 992 may be dedicated hardware, or the processor 201 that executes a program stored in the memory 202.

If the processing circuitry 992 is the dedicated hardware, the processing circuitry 992 is, for example, a single circuit, a composite circuit, a programmed processor, a parallel programmed processor, an ASIC, an FPGA, or a combination thereof.

ASIC is an abbreviation of Application Specific Integrated Circuit, and FPGA is an abbreviation of Field Programmable Gate Array.

The state replication apparatus 200 may include a plurality of processing circuits that substitute the processing circuitry 992. The plurality of processing circuits divide a role of the processing circuitry 992 among the plurality of processing circuits.

In the state replication apparatus 200, a part of functions may be realized by the dedicated hardware, and remaining functions may be realized by software or firmware.

Thus, the processing circuitry 992 may be realized by hardware, software, firmware, or a combination thereof.

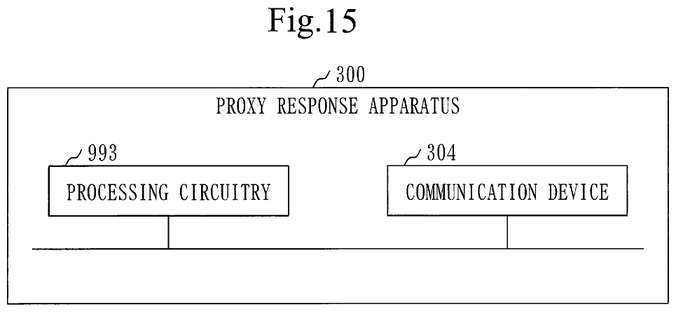

Based on FIG. 15, a hardware configuration of the proxy response apparatus 300 will be explained.

The proxy response apparatus 300 includes a processing circuitry 993.

The processing circuitry 993 is hardware that realizes the proxy response unit 321, the relay unit 322, and the storage unit 391.

The processing circuitry 993 may be dedicated hardware, or the processor 301 that executes a program stored in the memory 302.

If the processing circuitry 993 is the dedicated hardware, the processing circuitry 993 is, for example, a single circuit, a composite circuit, a programmed processor, a parallel programmed processor, an ASIC, an FPGA, or a combination thereof.

The proxy response apparatus 300 may include a plurality of processing circuits that substitute the processing circuitry 993. The plurality of processing circuits divide a role of the processing circuitry 993 among the plurality of processing circuits.

In the proxy response apparatus 300, a part of functions may be realized by the dedicated hardware, and remaining functions may be realized by software or firmware.

Thus, the processing circuitry 993 may be realized by hardware, software, firmware, or a combination thereof.

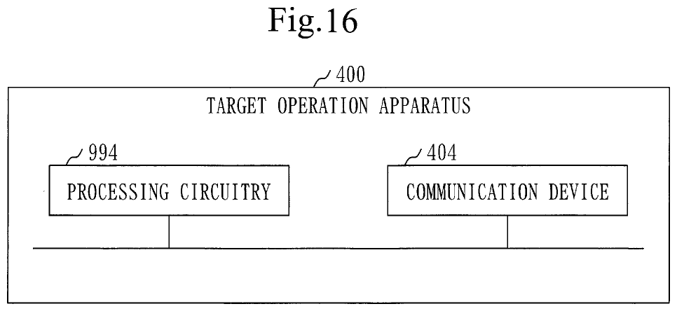

Based on FIG. 16, a hardware configuration of the target operation apparatus 400 will be explained.

The target operation apparatus 400 includes a processing circuitry 994.

The processing circuitry 994 is hardware that realizes the first virtual computer 411, the second virtual computer 412, the third virtual computer 413, and the storage unit 491.

The processing circuitry 994 may be dedicated hardware, or the processor 401 that executes a program stored in the memory 402.

If the processing circuitry 994 is the dedicated hardware, the processing circuitry 994 is, for example, a single circuit, a composite circuit, a programmed processor, a parallel programmed processor, an ASIC, an FPGA, or a combination thereof.

The target operation apparatus 400 may include a plurality of processing circuits that substitute the processing circuitry 994. The plurality of processing circuits divide a role of the processing circuitry 994 among the plurality of processing circuits.

In the target operation apparatus 400, a part of functions may be realized by the dedicated hardware, and remaining functions may be realized by software or firmware.

Thus, the processing circuitry 994 may be realized by hardware, software, firmware, or a combination thereof.

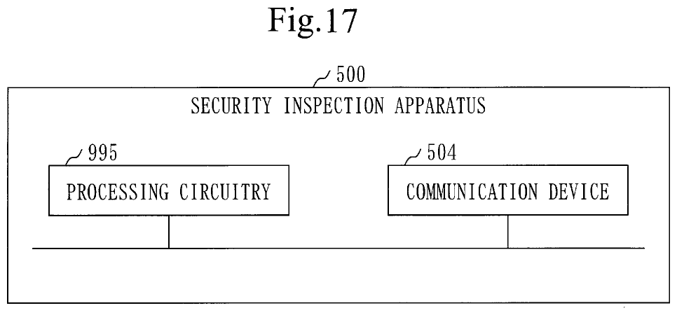

Based on FIG. 17, a hardware configuration of the security inspection apparatus 500 will be explained.

The security inspection apparatus 500 includes a processing circuitry 995.

The processing circuitry 995 is hardware that realizes the security inspection unit 510 and the storage unit 591.

The processing circuitry 995 may be dedicated hardware, or the processor 501 that executes a program stored in the memory 502.

If the processing circuitry 995 is the dedicated hardware, the processing circuitry 995 is, for example, a single circuit, a composite circuit, a programmed processor, a parallel programmed processor, an ASIC, an FPGA, or a combination thereof.

The security inspection apparatus 500 may include a plurality of processing circuits that substitute the processing circuitry 995. The plurality of processing circuits divide a role of the processing circuitry 995 among the plurality of processing circuits.

In the security inspection apparatus 500, a part of functions may be realized by the dedicated hardware, and remaining functions may be realized by software or firmware.

Thus, the processing circuitry 995 may be realized by hardware, software, firmware, or a combination thereof.

Embodiments are examples of favorable embodiments, and there is no intention to limit a technical scope of the present invention. Embodiment may be implemented in part, or may be implemented in combination with the other Embodiment(s). Procedures explained herein using flowcharts and the like may be changed according to circumstances.

### REFERENCE SIGNS LIST

100: state replication system; 101: communication channel; 110: security inspection system; 200: state replication apparatus; 201: processor; 202: memory; 203: auxiliary storage device; 204: communication device; 205: input/output interface; 211: communication control unit; 212: communication record unit; 213: snapshot acquisition unit; 221: replication unit; 291: storage unit; 292: communication unit; 293: acceptance unit; 300: proxy response apparatus; 301: processor; 302: memory; 303: auxiliary storage device; 304: communication device; 321: proxy response unit; 322: relay unit; 391: storage unit; 392: communication unit; 400: target operation apparatus; 401: processor; 402: memory; 403: auxiliary storage device; 404: communication device; 411: first virtual computer; 412: second virtual computer; 413: third virtual computer; 421: main apparatus; 422: first sub-apparatus; 423: second sub-apparatus; 491: storage unit; 492: communication unit; 500: security inspection apparatus; 501: processor; 502: memory; 503: auxiliary storage device; 504: communication device; 510: security inspection unit; 591: storage unit; 592: communication unit; 992, 993, 994, and 995: processing circuitry.

1-10. (canceled)

11. A state replication system comprising:
processing circuitry
to store an acquisition scenario in which transition order and a plurality of acquisition timings are specified, the transition order being order in accordance with which a state combination of a state of a main apparatus and a state of each of a plurality of sub-apparatuses is caused to transit, the plurality of acquisition timings being timings at which a snapshot combination of a snapshot of the main apparatus and a snapshot of the each sub-apparatus is acquired;
to generate communication, between the main apparatus and the each sub-apparatus, to cause the state combination to transit in accordance with the transition order specified in the acquisition scenario;
to record each of the communication generated between the main apparatus and the each sub-apparatus; and
to acquire a snapshot combination at each of the acquisition timings specified in the acquisition scenario.

12. The state replication system according to claim 11 wherein the processing circuitry,
when a combination of a state of the main apparatus and a state of the each sub-apparatus is specified as a replication state combination, replicates each of the main apparatus and the each sub-apparatus in the states of the replication state combination based on the acquired each snapshot combination and the recorded each communication.

13. The state replication system according to claim 12,
wherein the processing circuitry determines whether there is a relevant snapshot combination that is a snapshot combination representing a state of the main apparatus and a state of the each sub-apparatus that match those of the replication state combination, and, if there is not the relevant snapshot combination, chooses a snapshot combination representing the state of the each sub-apparatus that matches that of the state of the replication state combination, loads, in the each sub-apparatus, a snapshot of the each sub-apparatus included in the chosen snapshot combination, chooses any of the snapshot combinations as an alternative snapshot combination, loads, in the main apparatus, a snapshot of the main apparatus included in the alternative snapshot combination, chooses a record of communication that has been generated from a time when the alternative snapshot combination has been acquired until a time when the state of the main apparatus matches the state of the replication state combination, and causes the main apparatus to generate communication in accordance with the chosen record.

14. The state replication system according to claim 13 wherein the processing circuitry,
when the communication from the main apparatus to the each sub-apparatus is generated in order to replicate the state of the main apparatus, responds to the main apparatus in place of the each sub-apparatus.

15. The state replication system according to claim 14,
wherein the processing circuitry loads the snapshot of the each sub-apparatus in the each sub-apparatus after suspending operation of the each sub-apparatus, and resumes the operation of the each sub-apparatus after replicating each of the main apparatus and the each sub-apparatus in the states of the replication state combination.

16. The state replication system according to claim 15,
wherein the processing circuitry disconnects a session between the main apparatus and the each sub-apparatus after replicating each of the main apparatus and the each sub-apparatus in the states of the replication state combination, and resumes the operation of the each sub-apparatus after disconnecting the session between the main apparatus and the each sub-apparatus.

17. The state replication system according to claim 15 comprising:
the processing circuitry to, when communication is generated between the main apparatus and the each sub-apparatus after the operation of the each sub-apparatus is resumed, rewrite a sequence number included in each communication packet to be communicated between the main apparatus and the each sub-apparatus, and relay the each communication packet.

18. The state replication system according to claim 16 comprising:
the processing circuitry to, when communication is generated between the main apparatus and the each sub-apparatus after the operation of the each sub-apparatus is resumed, rewrite a sequence number included in each communication packet to be communicated between the main apparatus and the each sub-apparatus, and relay the each communication packet.

19. A non-transitory computer readable medium recording a state replication program which uses an acquisition scenario in which transition order and a plurality of acquisition timings are specified, the transition order being order in accordance with which a state combination of a state of a main apparatus and a state of each of a plurality of sub-apparatuses is caused to transit, the plurality of acquisition timings being timings at which a snapshot combination of a snapshot of the main apparatus and a snapshot of the each sub-apparatus is acquired, the state replication program causing a computer to execute:
a communication control process of generating communication, between the main apparatus and the each sub-apparatus, to cause the state combination to transit in accordance with the transition order specified in the acquisition scenario;
a communication record process of recording each of the communication generated between the main apparatus and the each sub-apparatus; and
a snapshot acquisition process of acquiring a snapshot combination at each of the acquisition timings specified in the acquisition scenario.

20. A security inspection system comprising:
the processing circuitry to store an acquisition scenario in which transition order and a plurality of acquisition timings are specified, the transition order being order in accordance with which a state combination of a state of a main apparatus and a state of each of a plurality of sub-apparatuses is caused to transit, the plurality of acquisition timings being timings at which a snapshot combination of a snapshot of the main apparatus and a snapshot of the each sub-apparatus is acquired;
to generate communication, between the main apparatus and the each sub-apparatus, to cause the state combination to transit in accordance with the transition order specified in the acquisition scenario;
to record each of the communication generated between the main apparatus and the each sub-apparatus;
to acquire a snapshot combination at each of the acquisition timings specified in the acquisition scenario;
to, when a combination of a state of the main apparatus and a state of the each sub-apparatus is specified as a replication state combination, replicate each of the main apparatus and the each sub-apparatus in states of the replication state combination based on the acquired each snapshot combination and the recorded each communication; and
to, after each of the main apparatus and the each sub-apparatus is replicated in the states of the replication state combination, carry out a security inspection for the main apparatus and the each sub-apparatus.

21. A non-transitory computer readable medium recording a security inspection program which uses an acquisition scenario in which transition order and a plurality of acquisition timings are specified, the transition order being order in accordance with which a state combination of a state of a main apparatus and a state of each of a plurality of sub-apparatuses is caused to transit, the plurality of acquisition timings being timings at which a snapshot combination of a snapshot of the main apparatus and a snapshot of the each sub-apparatus is acquired, the security inspection program causing a computer to execute:
a communication control process of generating communication, between the main apparatus and the each sub-apparatus, to cause the state combination to transit in accordance with the transition order specified in the acquisition scenario;
a communication record process of recording each of the communication generated between the main apparatus and the each sub-apparatus;
a snapshot acquisition process of acquiring a snapshot combination at each of the acquisition timings specified in the acquisition scenario;
a replication process of, when a combination of a state of the main apparatus and a state of the each sub-apparatus is specified as a replication state combination, replicating each of the main apparatus and the each sub-apparatus in states of the replication state combination based on the acquired each snapshot combination and the recorded each communication; and
a security inspection process of, after each of the main apparatus and the each sub-apparatus is replicated in the states of the replication state combination, carrying out a security inspection of the main apparatus and the sub-apparatus.
